(19) United States
(12) Patent Application Publication
(10) Pub. No.: US 2015/0362774 A1
(43) Pub. Date: Dec. 17, 2015

(54) LIQUID CRYSTAL DISPLAY DEVICE

(71) Applicant: Japan Display Inc., Tokyo (JP)

(72) Inventors: Tatsuya IDE, Tokyo (JP); Daisuke Sonoda, Tokyo (JP); Toshimasa Ishigaki, Tokyo (JP); Masanobu Ikeda, Tokyo (JP); Koji Ishizaki, Tokyo (JP); Hayato Kurasawa, Tokyo (JP); Yoshihiro Watanabe, Tokyo (JP)

(21) Appl. No.: 14/734,731

(22) Filed: Jun. 9, 2015

(30) Foreign Application Priority Data
Jun. 11, 2014 (JP) 2014-120615

(51) Int. Cl. G02F 1/1333; G02F 1/1343

(52) U.S. Cl. CPC G02F 1/13338; G02F 1/134336; G02F 1/134363

(57) ABSTRACT

The detection speed of a touch is improved and the reliability of a touch panel electrode formed on the outer side of a glass substrate is improved. A liquid crystal display device is provided in which a first electrode is formed on the outer side of a counter substrate as the first electrode is extended in a first direction. A second electrode extended in a direction perpendicular to the first direction is formed on the inner side of a TFT substrate. A touch panel function is provided on a liquid crystal display panel. The first electrode is formed of a metal or alloy. A protective film is formed to cover the first electrode. On the outer side of the first substrate, a groove is formed between the end portion of the protective film and the first electrode in parallel with the edge of the counter substrate.

### CLAIM OF PRIORITY

The present application claims priority from Japanese Patent Application JP 2014-120615 filed on Jun. 11, 2014, the content of which is hereby incorporated by reference into this application.

### BACKGROUND

The present invention relates to a display device, and more specifically to a liquid crystal display device of a lateral electric field drive mode including a touch panel.

A liquid crystal display device includes a TFT substrate on which pixels having a pixel electrode, a thin film transistor (TFT), and the like are formed in a matrix configuration, a counter substrate disposed opposite to the TFT substrate, and liquid crystals sandwiched between the TFT substrate and the counter substrate. The optical transmittance of liquid crystal molecules is controlled for the individual pixels, and images are formed. Since the liquid crystal display device is flat and light in weight, the use of the liquid crystal display device is increasing in various fields. A small-sized liquid crystal display device is widely used in a mobile telephone, a DSC (Digital Still Camera), and the like.

In these years, for an input method, a liquid crystal display device of a touch panel system is increasing. Conventionally, such a type of touch panel system is used in which a liquid crystal display panel and a touch panel are fabricated separately and the touch panel is mounted on the counter substrate of the liquid crystal display panel. Japanese Patent Application Laid-Open Publication No. 2011-543223 describes a configuration in which a touch panel metal interconnection is protected with a transparent organic resin.

### SUMMARY

However, it is strongly demanded to decrease the thickness of the entire liquid crystal display device as much as possible. In order to answer this demand, a system is developed in which the function of a touch panel is provided on a liquid crystal display panel itself. This system is a system in which one of touch panel electrodes is formed on the outer side of the counter substrate of a liquid crystal display panel and the other electrode is formed in the inside of the liquid crystal display panel.

In this case, since one of the electrodes is formed on the outer side of the counter substrate, it is necessary to protect the electrode. In the case where ITO (Indium Tin Oxide) is used, ITO is a corrosion resistant material, and ITO is relatively easily protected. However, since ITO has a large sheet resistance, the time constant becomes great, the time to detect a touch is prolonged, and it is difficult to make a quick response.

It is an object of the present invention is to implement a liquid crystal display device that combines the speed and the reliability of detection in a liquid crystal display device that a liquid crystal display panel itself has a touch panel function.

The present invention is to overcome the problems, and main specific schemes are as follows.

(1) A liquid crystal display device includes a liquid crystal display panel including liquid crystals sandwiched between a first substrate and a second substrate. In the liquid crystal display device, when a side of the first substrate or the second substrate facing the liquid crystals is defined as an inner side of the first substrate or an inner side of the second substrate and a side of the first substrate or the second substrate opposite to the side facing the liquid crystals is defined as an outer side of the first substrate or an outer side of the second substrate, a first electrode is formed on the outer side of the first substrate as the first electrode is extended in a first direction, a second electrode is formed on the inner side of the first substrate or the second substrate, the second electrode being extended in a direction perpendicular to the first direction, and a touch panel function is provided on the liquid crystal display panel. The first electrode is formed of a metal or alloy, and a protective film is formed to cover the first electrode. On the outer side of the first substrate, a groove is formed between an end portion of the protective film and the first electrode in parallel with an edge of the first substrate.

(2) In the liquid crystal display device in (1), the liquid crystal display panel is a liquid crystal display panel of an IPS mode, and a common electrode formed on the second substrate also functions as the second electrode.

(3) In the liquid crystal display device in (1), the groove is formed along four edges of the first substrate.

(4) In the liquid crystal display device in (1), a plurality of the grooves is formed in parallel with each other.

(5) In the liquid crystal display device in (1), a depth of the groove is 10 μm or greater and 30 μm or less.

(6) In the liquid crystal display device in (1), the protective film is formed by ink jet printing.

According to an aspect of the present invention, it is possible to implement a thin liquid crystal display device having a touch panel function of a fast detection speed and high reliability.

### BRIEF DESCRIPTION OF THE DRAWINGS

FIG. 1 is an exploded perspective view of a liquid crystal display device according to an embodiment of the present invention;

FIG. 2 is a cross sectional view of a liquid crystal display panel of an IPS mode;

FIG. 3 is a plan view of the shape of a common electrode of a TFT substrate;

FIG. 4 is a plan view of a liquid crystal display panel;

FIG. 5 is a plan view of the shape of a first electrode;

FIG. 6 is a plan view of another shape of the first electrode;

FIG. 7 is a cross sectional view of the first electrode according to an embodiment of the present invention;

FIG. 8 is a schematic diagram of a cross section in the case where a touch panel function is provided on a liquid crystal display panel;

FIG. 9 is a graph of differences in the time constant between the case where ITO is used for the first electrode and the case where a metal is used;

FIG. 10 is a cross sectional view of a counter substrate on which the first electrode is formed;

FIG. 11 is a cross sectional view of the counter substrate on which the first electrode is formed according to an embodiment of the present invention;

FIG. 12 is a schematic diagram of processes in which grooves are formed on the counter substrate;

FIG. 13 is an enlarged schematic diagram of processes in which grooves are formed on the counter substrate;

FIG. 14 is a plan view of the disposition of grooves on the corner portion of the counter substrate;

FIG. 15 is a cross sectional view of the detailed shape of a groove portion; and

FIG. 16 is a cross sectional view of another detailed shape of the groove portion.

### DETAILED DESCRIPTION

In the following, the content of an aspect of the present invention will be described in detail with reference to an embodiment.

### First Embodiment

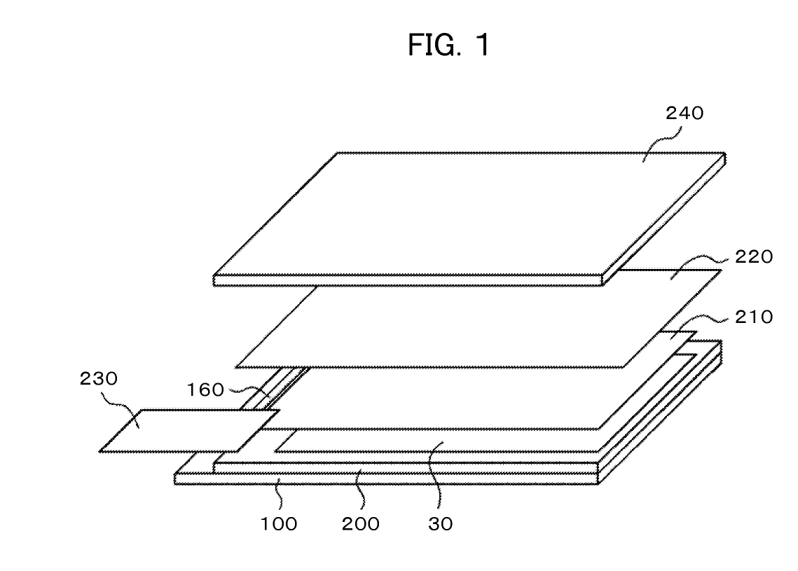

FIG. 1 is an exploded perspective view of a liquid crystal display device according to a first embodiment of the present invention. FIG. 1 is a liquid crystal display panel for display also provided with the function of a touch panel. In FIG. 1, a counter substrate 200 is disposed on a TFT substrate 100, and a first electrode 30 (referred to as a Rx electrode) for a touch panel is formed on the outer side of the counter substrate 200. A protective film 210 formed of a transparent organic material such as acrylic is formed to cover the first electrode 30. An upper polarizer 220 is disposed to cover the protective film 210. A cover glass 240 is disposed to cover the upper polarizer 220. Although not illustrated in FIG. 1, a lower polarizer is disposed on the lower side of the TFT substrate 100.

In FIG. 1, a touch panel flexible circuit board 230 is mounted on the end portion of the counter substrate in order to provide a connection to the first electrode 30 formed on the outer side of the counter substrate. It is noted that in order to operate the liquid crystal display panel in FIG. 1 as a touch panel, the function of a second electrode (referred to as a Tx electrode) is provided on a common electrode formed on the TFT substrate 100 of the liquid crystal display panel.

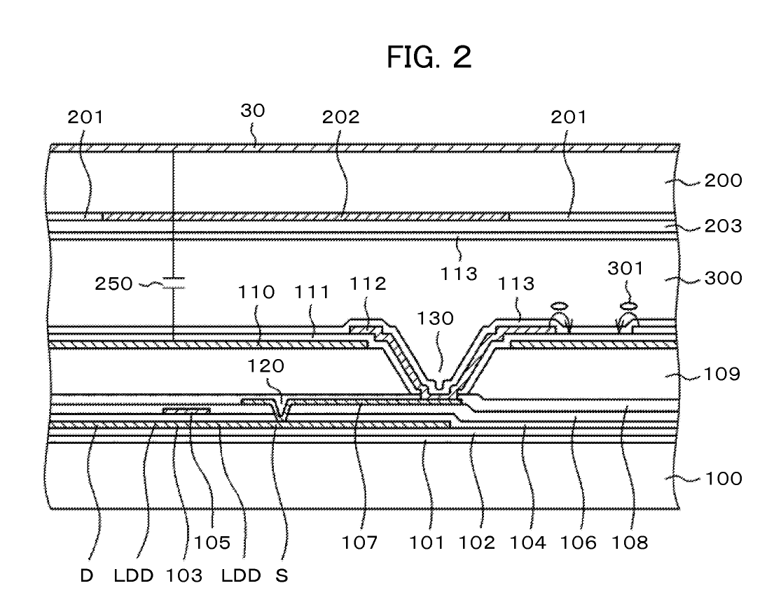

FIG. 2 is a cross sectional view of the liquid crystal display panel in FIG. 1. FIG. 2 is a cross sectional view of a liquid crystal display device of an IPS mode. In the following, the description will be made as the liquid crystal display device of the IPS mode is taken as an example. The present invention is also applicable to other liquid crystal display devices such as VA and TN liquid crystal display devices, not limited to the IPS mode.

In FIG. 2, a first base film 101 formed of SiN and a second base film 102 formed of SiO₂ are formed on the glass TFT substrate 100 by CVD (Chemical Vapor Deposition). The functions of the first base film 101 and the second base film 102 are to prevent a semiconductor layer 103 from being contaminated with impurities derived from the glass TFT substrate 100.

The semiconductor layer 103 is formed on the second base film 102. This semiconductor layer 103 is a film that an a-Si film is formed on the second base film 102 by CVD, and the film is annealed with a laser and transformed into a poly-Si film. This poly-Si film is patterned by photolithography.

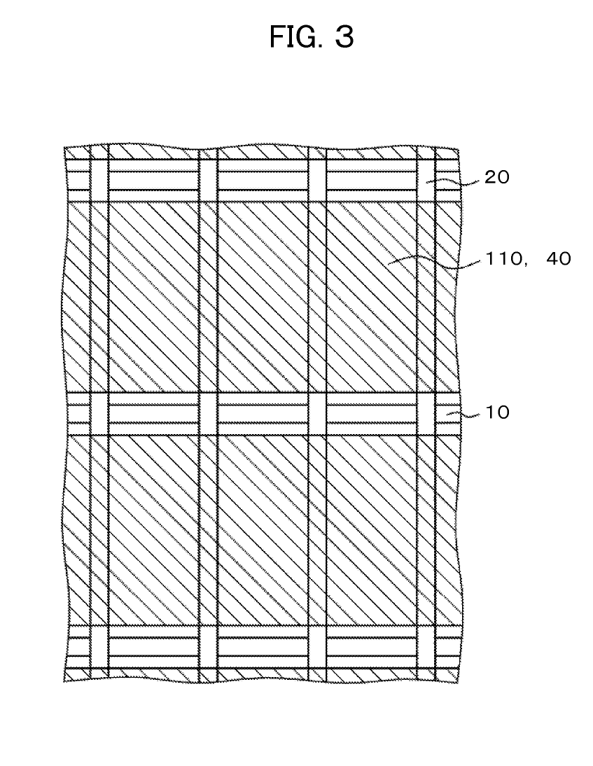

A gate insulating film 104 is formed on the semiconductor layer 103. This gate insulating film 104 is a SiO₂ film formed of TEOS (tetraethoxysilane). This film is also formed by CVD. A gate electrode 105 is formed on gate insulating film 104. A scanning line 10 illustrated in FIG. 3 also functions as the gate electrode 105. The gate electrode 105 is formed of an MoW film, for example. When it is necessary to decrease the resistance of the gate electrode 105 or the scanning line 10, an Al alloy is used.

The gate electrode 105 is patterned by photolithography. In this patterning, an impurity such as phosphorus or boron is doped into the poly-Si layer by ion implantation, and a source S or drain D is formed on the poly-Si layer. Moreover, a photoresist in patterning the gate electrode 105 is used, and a LDD (Lightly Doped Drain) layer is formed between the channel layer and the source S or drain D of the poly-Si layer.

After that, a first interlayer insulating film 106 is formed of SiO₂ as the gate electrode 105 is covered. The first interlayer insulating film 106 is provided to insulate the gate electrode 105 from a contact electrode 107. On the first interlayer insulating film 106 and the gate insulating film 104, a through hole 120 is formed to connect the source S of the semiconductor layer 103 to the contact electrode 107. Photolithography for forming the first interlayer insulating film 106 and photolithography for forming the through hole 120 on the gate insulating film 104 are performed at the same time.

The contact electrode 107 is formed on the first interlayer insulating film 106. The contact electrode 107 is connected to a pixel electrode 112 through a through hole 130. The drain D of the TFT is connected to a picture signal line 20 illustrated in FIG. 2 through a through hole 130 at a portion, not illustrated.

The contact electrode 107 and the picture signal line 20 are formed on the same layer at the same time. An AlSi alloy, for example, is used for the contact electrode 107 and the picture signal line (in the following, they are represented by the contact electrode 107) in order to decrease the resistance. Since the AlSi alloy produces a hillock, or Al is diffused to other layers, such a structure is provided in which AlSi is sandwiched between a barrier layer formed of MoW, not illustrated, for example, and a cap layer.

An inorganic passivation film (an insulating film) 108 is coated over the contact electrode 107, and the TFT is protected entirely. The inorganic passivation film 108 is formed by CVD similarly to the first base film 101. An organic passivation film 109 is formed to cover the inorganic passivation film 108. The organic passivation film 109 is formed of a photosensitive acrylic resin. The organic passivation film 109 can also be formed of a silicone resin, epoxy resin, polyimide resin, and the like other than an acrylic resin. Since the organic passivation film 109 has a function of a planarization film, the organic passivation film 109 is formed thick. Although the film thickness of the organic passivation film 109 ranges from 1 to 4 μm, the film thickness is about 2 μm in many cases.

In order to provide continuity between a pixel electrode 110 and the contact electrode 107, the through hole 130 is formed on the inorganic passivation film 108 and the organic passivation film 109. A photosensitive resin is used for the organic passivation film 109. After a photosensitive resin is coated, the resin is exposed, and only portions to which light is applied are dissolved in a specific developer. In other words, the formation of a photoresist can be omitted by using a photosensitive resin. After the through hole 130 is formed on the organic passivation film 109, the organic passivation film is baked at a temperature of about 230° C., and then the organic passivation film 109 is completed.

After that, ITO (Indium Tin Oxide) to be the common electrode 110 is formed by sputtering. This ITO is patterned in such a manner that the ITO is removed from the through hole 130 and regions around the through hole 130 and regions corresponding to the upper part of the scanning line. This is because this ITO is removed on the upper part of the scanning line and the common electrode is caused to function as the second electrode of the touch panel. As illustrated in FIG. 3, the common electrode 110 is formed in such a manner that the common electrode 110 is in parallel with the scanning line and shared between the pixels in the direction in which the scanning line is extended.

After that, SiN to be a second interlayer insulating film 111 is formed on the entire surface by CVD. After that, in the through hole 130, a through hole to provide continuity between the contact electrode 107 and the pixel electrode 112 is formed on the second interlayer insulating film 111 and the inorganic passivation film 108.

After that, ITO is formed by sputtering and patterned, and then the pixel electrode 112 is formed. In FIG. 2 and the subsequent diagrams, a planar form of the pixel electrode 112 according to an embodiment of the present invention is illustrated. An alignment film material is coated on the pixel electrode 112 by flexographic printing, ink jet printing, or the like, and baked, and an alignment film 113 is formed. For the alignment process for the alignment film 113, rubbing as well as optical alignment with polarized ultraviolet rays are used.

When a voltage is applied across the pixel electrode 112 and the common electrode 110, an electric flux line is produced as illustrated in FIG. 1. Liquid crystal molecules 301 are rotated with this electric field, the light quantity to be transmitted through a liquid crystal layer 300 is controlled for the individual pixels, and an image is formed.

In FIG. 2, a counter substrate 200 is disposed as the liquid crystal layer 300 is sandwiched between the counter substrate 200 and the TFT substrate 100. A color filter 201 is formed on the inner side of the counter substrate 200. For the color filter 201, red, green, and blue color filters are formed on the individual pixels, and images are formed by these color filters. A black matrix 202 is formed between the color filter 201 and the color filter 201 for improving the contrast of images. It is noted that the black matrix 202 also functions as the light shielding film of the TFT, and prevents a photocurrent from being carried through the TFT.

An overcoat film 203 is formed to cover the color filter 201 and the black matrix 202. Since the surfaces of the color filter 201 and the black matrix 202 are irregular, the surfaces are flattened with the overcoat film 203. An alignment film 113 is formed on the overcoat film for determining the initial orientation of liquid crystals. For the alignment process for the alignment film 113, rubbing or optical alignment is used similarly to the alignment film 113 on the TFT substrate 100 side.

The first electrode 30 that causes the liquid crystal display panel to function as the touch panel is formed on the outer side of the counter substrate. As illustrated in FIG. 2, an electrostatic capacitance 250 is formed between the first electrode 30 formed on the outer side of the counter substrate 200 and the second electrode 40 that the common electrode 110 formed on the TFT substrate 100 also functions, and a touch position is detected by detecting a change in the capacitance 250.

FIG. 3 is a plan view of the TFT substrate 100. In FIG. 3, the scanning line 10 is extended in the lateral direction, and arranged in the vertical direction. Moreover, the picture signal line 20 is extended in the vertical direction, and arranged in the lateral direction. It is the pixel that is a region surrounded by the scanning line 10 and the picture signal line 20. In FIG. 3, the pixel electrode, the TFT, and the like are omitted in the pixel. In FIG. 3, the common electrodes 110 is formed in stripes in the lateral direction in common with the pixels formed between the scanning line 10 and the scanning line 10. The common electrodes 110 in stripes are used as the second electrode 40 of the touch panel.

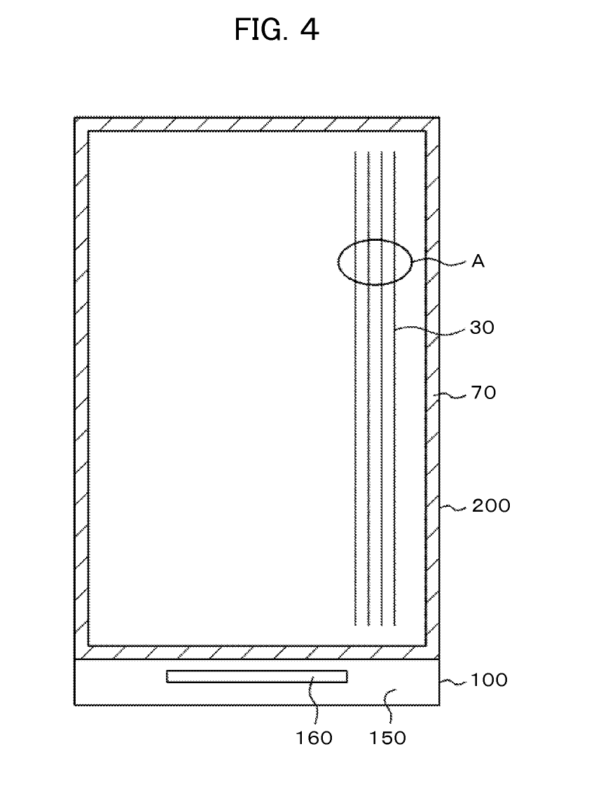

The first electrode 30 of the touch panel is formed on the outer side of the counter substrate 200. FIG. 4 is a plan view of the liquid crystal display panel in the state in which the first electrode 30 is formed. In FIG. 4, the counter electrode 200 is disposed on the TFT substrate 100, and the TFT substrate 100 is bonded to the counter electrode with a sealing material formed around the substrates. The TFT substrate 100 is formed greater than the counter substrate 200, and a portion where only the TFT substrate 100 is provided is a terminal portion 150 on which an IC driver that drives liquid crystals is mounted. Although not illustrated in the drawing, a flexible circuit board that drives the liquid crystal display panel is connected to the terminal portion 150, and a touch panel flexible circuit board 230 is connected to the counter substrate 200 as illustrated in FIG. 1.

In FIG. 4, the first electrode 30 is formed as the first electrode 30 is extended in the direction parallel with the long edge of the counter substrate 200. In other words, the first electrode 30 is extended in the direction perpendicular to the edge along which the terminal portion 150 is formed. The touch panel second electrode 40 formed on the TFT substrate 100 that the common electrode 110 also functions is formed as the touch panel second electrode 40 is extended in the direction parallel with the short edge of the counter substrate 200. In other words, the second electrode 40 is extended in the direction parallel with the edge along which the terminal portion 150 is formed. In other words, the first electrode 30 and the second electrode 40 are extended in the directions perpendicular to each other.

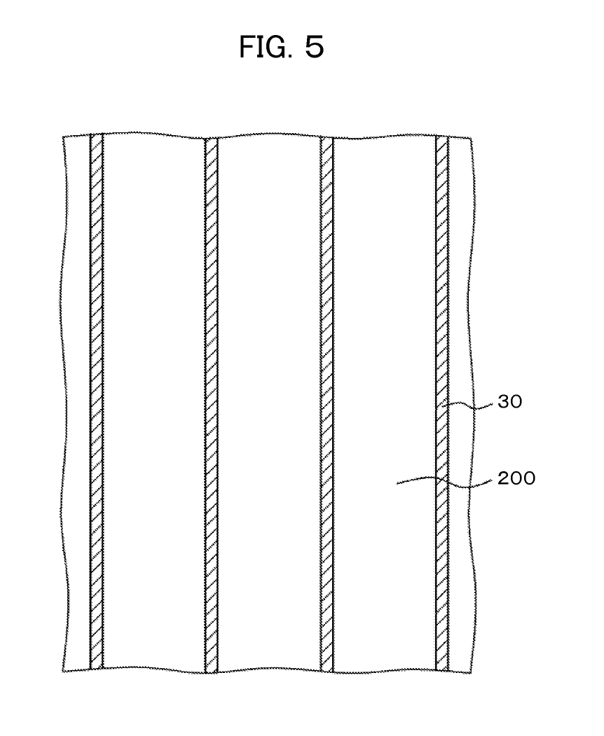

FIG. 5 is an enlarged diagram of the touch panel first electrode 30 formed on the outer side of the counter substrate 200 illustrated in FIG. 4. In FIG. 5, ITO that is a transparent electrode is used for the first electrode 30. However, since ITO has a large specific resistance, the interconnection resistance is large. Since a touch position is detected by detecting a change in the capacitance 250, the time constant becomes large when the interconnection resistance is large, and the detection speed becomes slow.

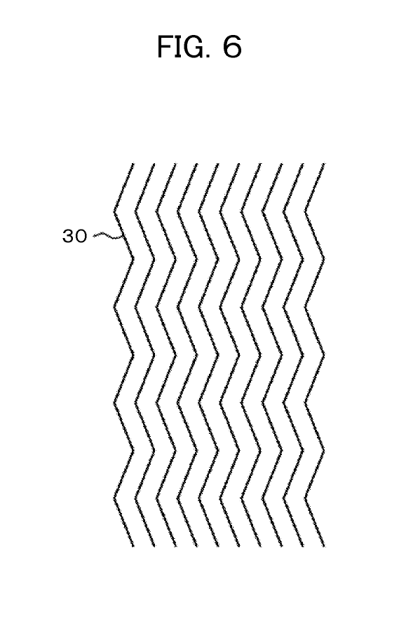

Therefore, in the embodiment of the present invention, a metal or alloy is used for the first electrode 30. However, since a metal or alloy has a larger reflectance than the reflectance of ITO, interconnection patterns are noticeable. Therefore, for example, the shape of the interconnection pattern is formed as illustrated in FIG. 6, and the interconnection patterns are not noticeable. It is noted that FIG. 6 is an exemplary interconnection pattern.

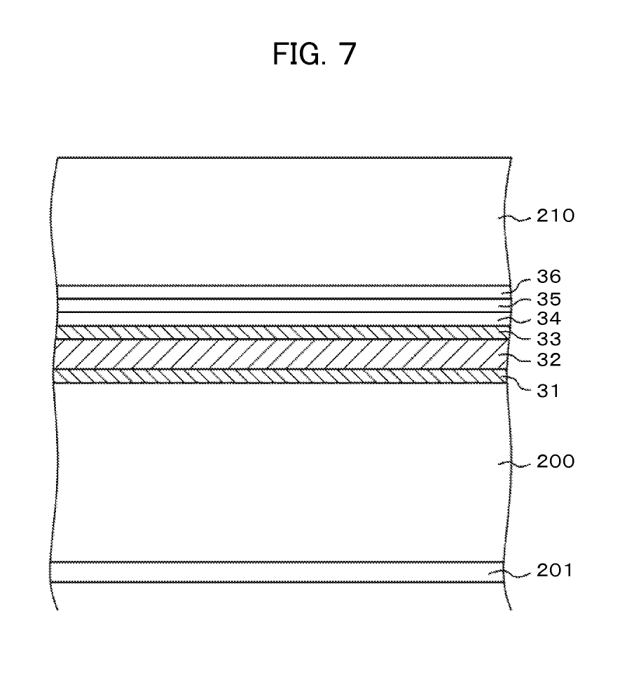

FIG. 7 is a cross sectional view of the first electrode 30 of the counter substrate 200. In FIG. 7, the first electrode 30 is formed on the counter substrate 200. The first electrode 30 has a three-layer structure. A main electrode 32 is an Al alloy, and an AlNd alloy is used, for example. This alloy is used for decreasing the electrical resistance. Below the Al alloy, an Mo alloy, MoNb, for example, is used for a base metal 31. Moreover, on the Al alloy, an Mo alloy, MoNb, for example, is used for a cap metal 33.

Since a metal or alloy has a high reflectance, a three-layer anti-reflective film is formed. These three layers prevent reflection by the combination of a layer 34 having a small refractive index, a layer 35 having a large refractive index, and a layer 36 having a small refractive index. For the substance of the layer 34 having a small refractive index and formed on the cap metal 33, IGO (Indium Garium Oxide) is used, for example. For the substance of the layer 35 having a large refractive index and formed on the layer 34, MoNb is used, for example. For the substance of the layer 36 having a small refractive index and formed on the layer 35, IGO is used, for example.

As described above, six layers including the anti-reflective film as the first interconnection 30 are formed on the counter substrate 200. These six layers are continuously formed by sputtering, for example. After that, these six layers are patterned by photolithography, and the first electrode 30 is formed. The first electrode formed of a metal or alloy can have a mesh resistance one-tenth or less of the mesh resistance of a first electrode formed of ITO.

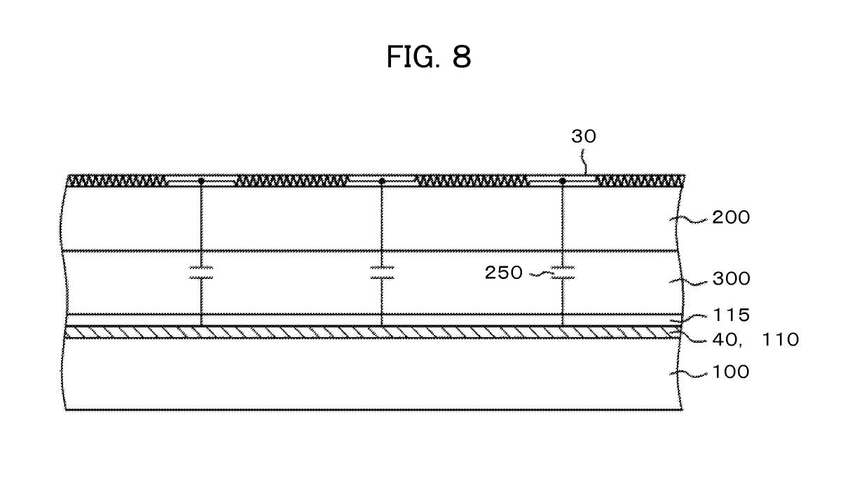

FIG. 8 is a schematic diagram of the configuration of the electrodes forming the touch panel. As illustrated in FIG. 8, the liquid crystal display panel also functions as the configuration of the touch panel. In FIG. 8, the common electrode 110 that is also used for the second electrode 40 of the touch panel is formed on the TFT substrate 100, and an upper interconnection 115 including the pixel electrode is formed on the common electrode 110. On the other hand, the touch panel first electrode 30 is formed on the outer side of the counter substrate 200. In FIG. 8, the capacitance 250 that detects a touch position is formed between the first electrode 30 formed on the outer side of the counter substrate 200 and the second electrode 40 as the common electrode 110 formed on the TFT substrate 100.

A touch position is detected by the charging and discharging of the capacitance 250. When the time constant of a circuit including the capacitance 250 is large, high speed detections are not enabled. The time constant is a product of the resistance and the capacitance. A metal or alloy is used for the first electrode 30 in the embodiment of the present invention, so that the interconnection resistance of the first electrode 30 can be decreased, and the time constant can be shortened.

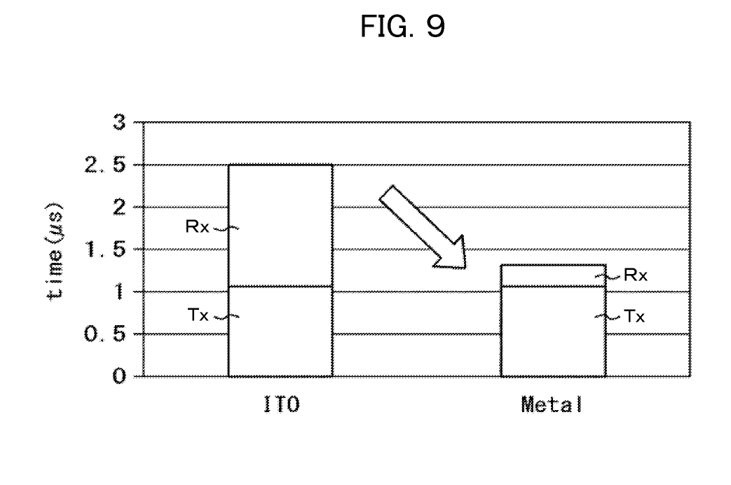

FIG. 9 is a graph of the comparison of time constants between the case where ITO is used for the first electrode and the case where a metal or alloy is used. The time constant is changed in proportion to the resistance. In FIG. 9, since the common electrode is used for the second electrode, the material is not changeable. On the other hand, the material of the first electrode can be freely changed. In FIG. 9, the material of the first electrode is changed from ITO to a metal or alloy, so that the interconnection resistance of the first electrode can be decreased, and the time constant is greatly decreased.

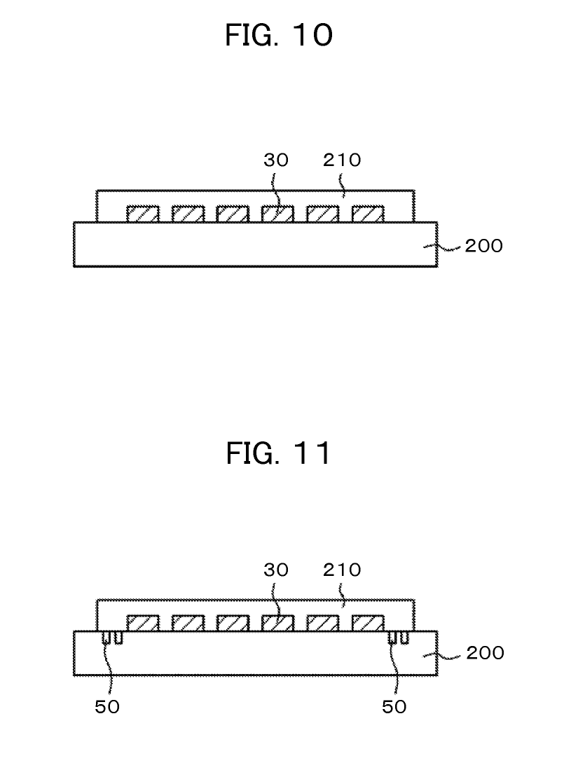

As described above, the first electrode is formed of a metal or alloy, so that the detection speed of the touch panel can be greatly increased. However, the electrode formed of a metal or alloy mechanically weak, and interconnections are easily broken. Although the anti-reflective film exists on the alloy layer, the thickness of the anti-reflective film is very thin, and any protective function is not provided. Therefore, as illustrated in FIG. 10, in order to protect the second electrode, the protective film 210 formed of a transparent resin such as acrylic is formed to cover the first electrode 30.

FIG. 10 is a cross sectional view of the protective film 210. In FIG. 10, the protective film 210 is formed to cover the first electrode 30 formed on the counter substrate 200. The protective film 210 is formed thick in a thickness of about 2 μm for mechanical protection.

On the other hand, a metal such as Al corrodes with moisture. Moisture is mainly entered from the interface between the glass counter substrate 200 and the protective film 210. Therefore, when the route from the end portion of the protective film 210 to the first electrode 30 is long, the time that the first electrode 30 corrodes can be prolonged accordingly. In other words, the lifetime of products can be prolonged.

FIG. 11 is a schematic cross sectional view of the embodiment of the invention of the present application. In FIG. 11, the first electrode 30 formed of a metal or alloy is formed on the glass counter substrate 200, and the protective film 210 is covered over the first electrode 30. The feature of the configuration in FIG. 11 is in that a groove 50 is formed at two places on the counter substrate 200 from the end portion of the protective film 210 to the first interconnection 30. Since moisture is entered along the interface between the glass counter substrate 200 and the protective film 210, the formation of the groove 50 provides a long distance along which moisture reaches the first electrode 30 accordingly, and the time that the first electrode 30 corrodes with moisture can be prolonged. FIG. 11 is the case where two grooves 50 are formed. It may be fine that three grooves 50 or more are formed when a space is allowed, or one groove 50 is formed when a space is not allowed.

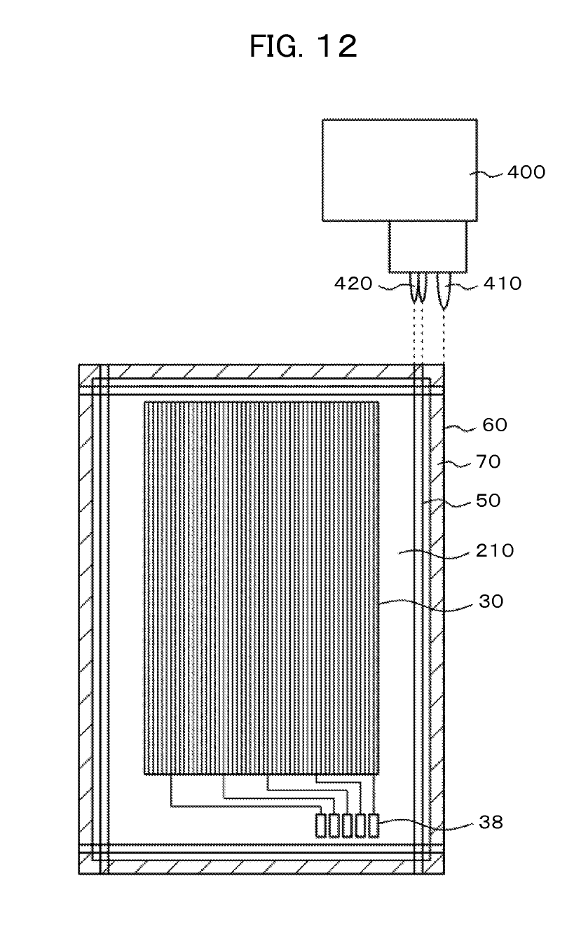

FIG. 12 is a schematic diagram of the grooves 50 formed on the counter substrate 200 and a method for forming the grooves 50. Since it is not efficient that the liquid crystal display panel is fabricated one by one, a plurality of liquid crystal display panels is formed on a mother substrate, and the liquid crystal display panels are separated individually from the mother substrate after completion. The liquid crystal display panels are separated in which the mother substrate is scribed along a separation line (a scribing line) 60 and then an impact is applied to glass for separation.

In FIG. 12, the protective film 210 is formed close to the end portion of the counter substrate 200 as the first electrode 30 is covered. The protective film 210 is formed not to cover the scribing line 60. This is because when the organic protective film 210 in a thickness of 2 μm exists on the scribing line 60, the mother substrate is not enabled to be separated along the scribing line even though an impact is applied.

In FIG. 12, the first electrode 30 is formed with a terminal 38 to be connected to the touch panel flexible circuit board 230. Although the first electrode 30 is covered with the protective film 210, the protective film 210 is removed from the portion of the terminal 38 by photolithography, for example. Alternatively, in the case where the protective film 210 is formed by ink jet printing, the protective film 210 is not formed only on the portion of the terminal 38. It is noted that as illustrated in FIG. 12, the grooves 50 are formed on the outer side of the terminal 38.

As illustrated in FIG. 12, the grooves 50 formed on the counter substrate 200 are formed in the state of the mother substrate 200 at the same time in scribing. Therefore, the depth of the groove 50 is smaller than the depth of the scribing line. The groove 50 in this depth can be provided using a scribing device in which a groove cutting tool 430 is set shorter than a cutting tool 410 for the scribing line as illustrated in FIG. 12.

As illustrated in FIG. 12, since the grooves 50 can be formed on the counter substrate 200 at the same time in scribing, the number of process steps is not increased. The grooves 50 can be formed along four edges in scribing. The number of the groove 50 can be changed by increasing or decreasing the number of the groove cutting tools.

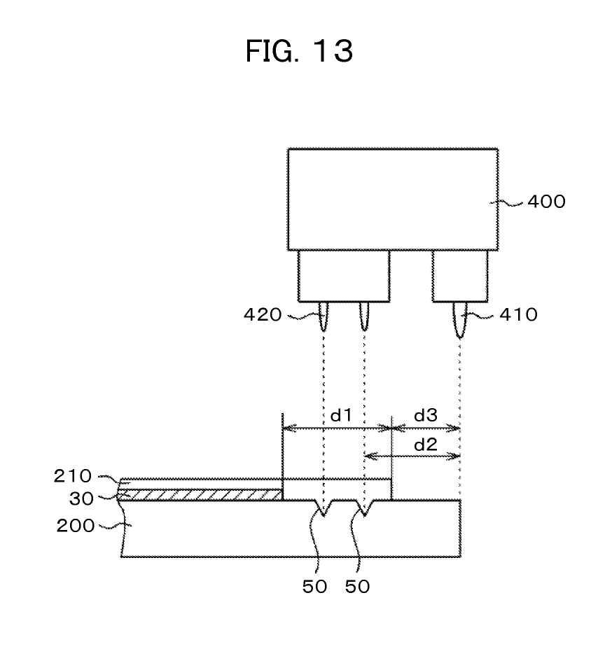

FIG. 13 is an enlarged cross sectional view of the formation of a scribing line using a scriber and the formation of the grooves 50. As illustrated in FIG. 13, since a scribing cutting tool 400 is longer than a groove cutting tool 420, the scribing line is formed deeper than the grooves. In FIG. 13, after the scribing line 60 and the grooves 50 are formed using this scriber, the protective film 210 is formed, an impact is applied, and individual liquid crystal display panels are separated along the scribing line 60.

In FIG. 13, a distance d3 from the end portion of the counter substrate 200 to the end portion of the protective film 210 is about 0.2 mm, and a distance d2 from the end portion of the counter substrate 200 to the center of the groove 50 on the outer side is about 0.25 mm. Moreover, a distance d1 from the end portion of the first electrode 30 to the end portion of the protective film 210 is about 0.3 mm.

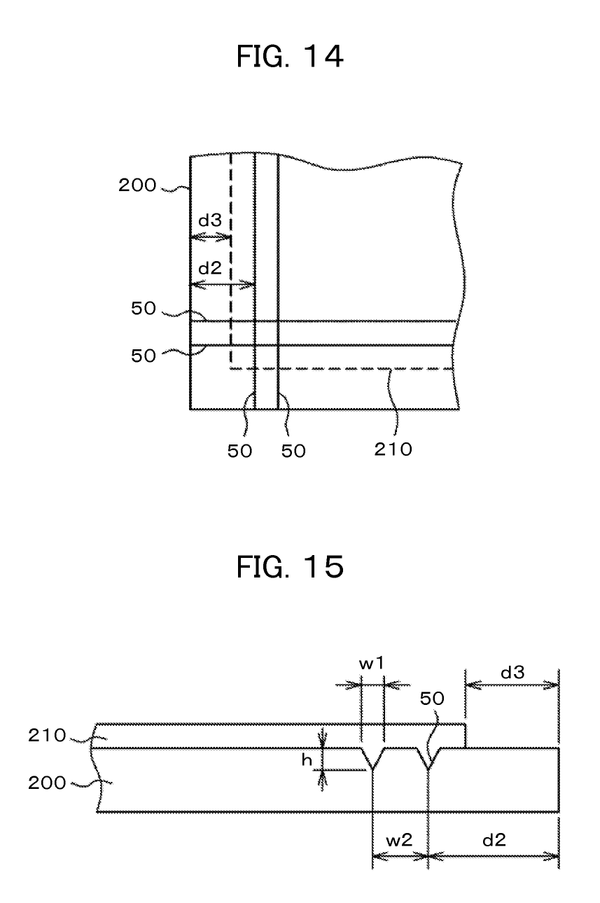

FIG. 14 is an enlarged plan view of the corner portion of the counter substrate 200. In FIG. 14, the protective film 210 is formed to the portion near the end portion of the counter substrate 200. The distance d3 from the end portion of the protective film 210 to the end portion of the counter substrate 200 is about 0.2 mm. Moreover, two grooves 50 are formed in parallel with each other individually along the edges. The distance d2 from the center of the groove 50 on the outer side to the end portion of the counter substrate 200 is about 0.25 mm.

FIG. 15 is an enlarged cross sectional view of the portion of the grooves 50. In FIG. 15, a depth h of the groove 50 ranges from 10 to 30 μm. This is because when h is too small, the effect of forming the grooves 50 becomes small, whereas when h is large, a liquid crystal display panel is likely to be broken at the portion of the grooves 50 with an impact in the separation of individual liquid crystal display panels from the mother substrate. For the width of the groove 50, it is desirable to provide a width of 30 μm or less even on a portion where the groove 50 has the widest width because of the same reason. Moreover, the spacing between the grooves 50, that is, a distance w2 between the centers of the grooves 50 can be 60 μm or less. It is noted that the spacing between the grooves 50 can be decreased to a degree that glass is not destroyed because of the interference between the grooves.

In FIG. 15 and the other diagrams, the grooves 50 are filled with the protective film 210. In the case where the protective film 210 is applied by ink jet printing, it is possible to fully fill the grooves 50 with the protective film 210 by increasing the discharge amount on the portion of the grooves 50 because the portion where the grooves 50 exist is known in advance.

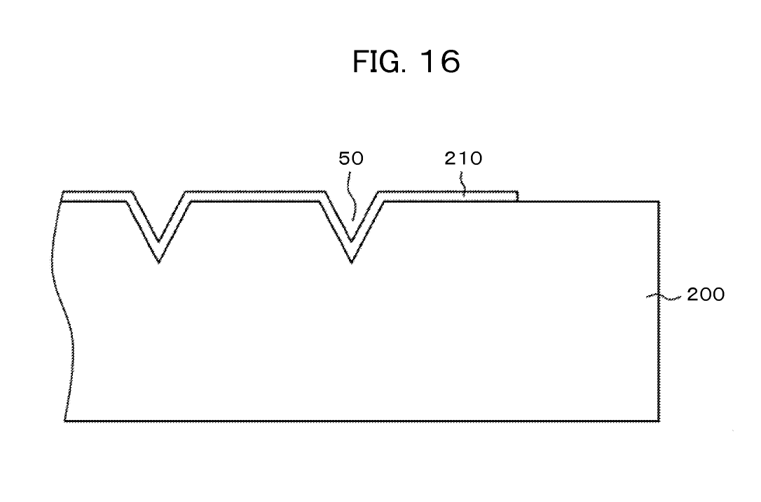

On the other hand, as illustrated in FIG. 16, the similar effect can be obtained without filly filling the grooves 50 with the protective film 210. In FIG. 16, the protective film 210 is formed along the shape of the groove 50. It is noted that since the portion of the grooves 50 is scribed using the cutting tool 420, a large number of irregularities sometimes exist. In this case, it is necessary to fully fill these irregularities with the protective film 210. Therefore, it is desirable that the film thickness of the protective film 210 be more increased on the portion of the grooves 50 by increasing the discharge amount in ink jet printing even in the case where the grooves 50 are not fully filled with the protective film 210.

In the description above, the protective film 210 is formed of an organic material. However, it may be fine that an inorganic insulator such as SiN is used when mechanical protection can be provided. Also in this case, the embodiment of the present invention described above is applicable.

Moreover, in the description above, the description is made in which as illustrated in FIG. 4, the first electrode 30 is extended in the direction perpendicular to the edge along which the terminal portion 150 is formed, and the second electrode 40 formed on the TFT substrate 100 is extended in the direction perpendicular to the first electrode 30. However, it may be fine that the first electrode 30 is extended in the direction parallel with the edge along which the terminal portion 150 is formed and the second electrode 40 is extended in the direction perpendicular to the first electrode 30.

In the description above, the liquid crystal display panel of the IPS mode is described. The IPS mode is characterized in that the pixel electrode and the common electrode can be formed on the TFT substrate. However, the embodiment of the present invention is also applicable to a liquid crystal display device in which the common electrode is formed on the counter substrate side as in the VA mode or TN mode. In this case, the common electrode formed on the counter substrate side can be used for a touch panel second electrode by separating the common electrode.

What is claimed is:

1. A liquid crystal display device comprising:
a liquid crystal display panel including liquid crystals sandwiched between a first substrate and a second substrate,
wherein: when a side of the first substrate or the second substrate facing the liquid crystals is defined as an inner side of the first substrate or an inner side of the second substrate and a side of the first substrate or the second substrate opposite to the side facing the liquid crystals is defined as an outer side of the first substrate or an outer side of the second substrate,
a first electrode is formed on the outer side of the first substrate as the first electrode is extended in a first direction, a second electrode is formed on the inner side of the first substrate or the second substrate, the second electrode being extended in a direction perpendicular to the first direction, and a touch panel function is provided on the liquid crystal display panel;
the first electrode is formed of a metal or alloy, and a protective film is formed to cover the first electrode; and
on the outer side of the first substrate, a groove is formed between an end portion of the protective film and the first electrode in parallel with an edge of the first substrate.

2. The liquid crystal display device according to claim 1, wherein the liquid crystal display panel is a liquid crystal display panel of an IPS mode, and a common electrode formed on the second substrate also functions as the second electrode.

3. The liquid crystal display device according to claim 1, wherein the groove is formed along four edges of the first substrate.

4. The liquid crystal display device according to claim 1, wherein a plurality of the grooves is formed in parallel with each other.

5. The liquid crystal display device according to claim 1, wherein a depth of the groove is 10 μm or greater and 30 μm or less.

6. The liquid crystal display device according to claim 1, wherein the protective film is formed by ink jet printing.
